(19) United States
(12) Patent Application Publication
(10) Pub. No.: US 2016/0342780 A1
(43) Pub. Date: Nov. 24, 2016

(54) SMART TV CONTROL METHOD

(71) Applicant: Primax Electronics Ltd., Neihu (TW)

(72) Inventors: CHENG-LIN LEE, Neihu (TW); CHI-SHIU CHEN, Neihu (TW)

(21) Appl. No.: 14/863,234

(22) Filed: Sep. 23, 2015

(30) Foreign Application Priority Data
May 20, 2015 (TW) 104116022

(51) Int. Cl. G06F 21/32; G06F 17/30

(52) U.S. Cl. CPC G06F 21/32; G06F 17/30312

(57) ABSTRACT

A smart TV control method is provided. Firstly, a smart TV is turned on through a remote controller. Then, the smart TV judges whether an authenticating process is activated. If the authenticating process is activated, the smart TV receives a fingerprint information from a fingerprint reader of the remote controller and starts to perform the authenticating process. If the smart TV judges that the fingerprint information is successfully authenticated in the authenticating process, the smart TV enters a user mode corresponding to the authenticated fingerprint information and the smart TV controls the fingerprint reader to enter a sleep mode. Consequently, the power-saving efficacy is enhanced.

### FIELD OF THE INVENTION

The present invention relates to a TV control method, and more particularly to a smart TV control method.

### BACKGROUND OF THE INVENTION

Traditional televisions have become popular in the families of most people. The televisions can receive television signals from television stations to broadcast the corresponding TV channels. Consequently, users can make use of televisions to retrieve information, get audiovisual entertainment or achieve other efficacies. As known, some television programs broadcasted by some TV channels are not suitable for all users to watch. For example, restricted movies are not suitable for children to watch. However, the users cannot set limitations on the traditional televisions in order to allow specified TV channels to be watched by specified users.

With increasing development of science and technology, a smart TV has been introduced into the market. The smart TV is allowed to lock some TV channels according to the settings of the user. Once a TV channel is locked, the user has to input a password to unlock the TV channel. After the TV channel is unlocked, the programs of the unlocked TV channel can be watched. Consequently, the TV channels which are not suitable for some users to watch can be effectively limited.

Moreover, according to the settings of a specified user, a user mode of the smart TV corresponding to the specified user can be established. In the user mode, the TV interface to be displayed and the stereo settings can be determined according to the user's preference. For example, in case that the user A who likes to watch sports programs add plural sports channels into the user mode corresponding to the user A, the TV interface in the user mode can simultaneously display plural sport channels to be selected by the user, and the stereo settings (including the sound volume setting or the setting of enabling or disabling a heavy bass) complies with the user's preference. Moreover, the user mode can be locked through an account and a password. That is, the user has to previously set the account and the password corresponding to the user mode. After the correct account and password are inputted, the smart TV enters the corresponding user mode.

However, since each user mode corresponds to the different user, it is necessary to set the corresponding account and the corresponding password for creating the user mode. Since the user has to memorize the account and the password, the user possibly forgets the account and the password.

Therefore, there is a need of providing a smart TV control method for allowing a smart TV to enter a user mode without the need of inputting an account and a password.

### SUMMARY OF THE INVENTION

An object of the present invention provides a smart TV control method that is operated by the user more conveniently.

In accordance with an aspect of the present invention, there is provided a smart TV control method. Firstly, a smart TV is turned on through a remote controller. Then, the smart TV judges whether an authenticating process is activated. If the smart TV judges that the authenticating process is activated, the smart TV judges receives a fingerprint information from a fingerprint reader of the remote controller and starts to perform the authenticating process. Then, the smart TV judges whether the fingerprint information is successfully authenticated in the authenticating process. If the smart TV judges that the fingerprint information is successfully authenticated in the authenticating process, the smart TV enters a user mode corresponding to the authenticated fingerprint information, and the smart TV controls the fingerprint reader to enter a sleep mode.

From the above descriptions, the present invention provides a smart TV control method. By the smart TV control method, the smart TV is allowed to enter a user mode corresponding to the authenticated fingerprint information. That is, the user neither memorizes the account and the password nor inputs the account and the password into the smart TV. Consequently, the process of allowing the user to login into the smart TV will be simplified. Moreover, after the authenticating process for the smart TV is completed, the remote controller controls the fingerprint reader to enter the sleep mode. Since the power consumption is reduced, the power-saving efficacy of the remote controller is enhanced.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a control system for implementing a smart TV control method according to a first embodiment of the present invention;

FIG. 2 is a flowchart illustrating a smart TV control method according to a first embodiment of the present invention;

FIG. 3 schematically illustrates the contents shown on the smart TV in a first user mode by the smart TV control method according to the first embodiment of the present invention;

FIG. 4 schematically illustrates the contents shown on the smart TV in a second user mode by the smart TV control method according to the first embodiment of the present invention;

FIG. 5 is a schematic functional block diagram illustrating a control system for implementing a smart TV control method according to a second embodiment of the present invention; and

FIG. 6 is a flowchart illustrating a smart TV control method according to a second embodiment of the present invention.

### DETAILED DESCRIPTION OF THE PREFERRED EMBODIMENT

For solving the drawbacks of the conventional technologies, the present invention provides a smart TV control method.

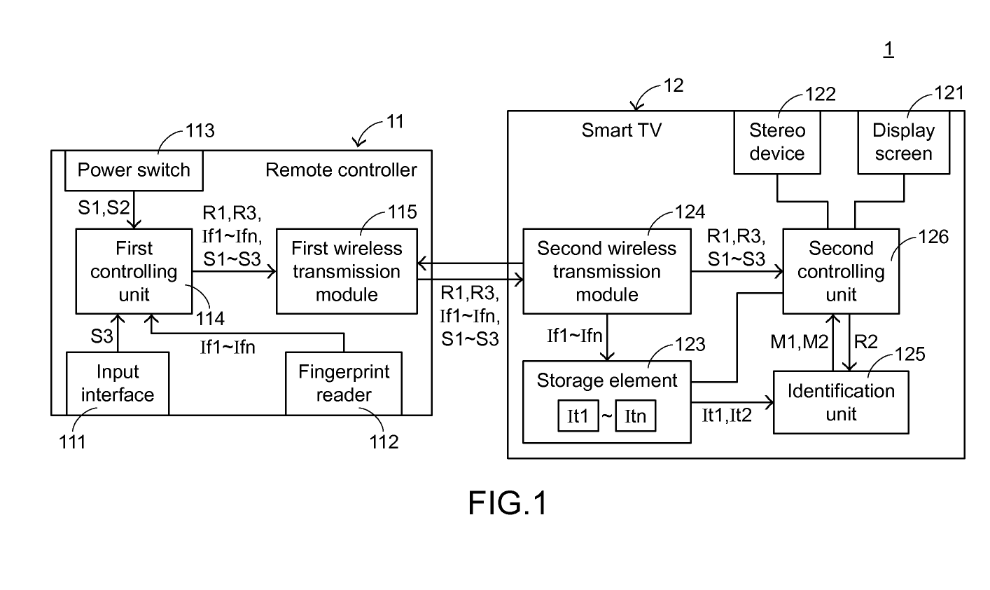

First of all, the architecture of a control system according to the present invention will be illustrated as follows. FIG. 1 is a schematic functional block diagram illustrating a control system for implementing a smart TV control method according to a first embodiment of the present invention. As shown in FIG. 1, the control system 1 comprises a remote controller 11 and a smart TV 12. The remote controller 11 comprises an input interface 111, a fingerprint reader 112, a power switch 113, a first controlling unit 114 and a first wireless transmission module 115. The input interface 111 is exposed outside the remote controller 11. In response to the user's operation, the input interface 111 issues a corresponding operating signal S3 to the smart TV 12. The fingerprint reader 112 is disposed on the remote controller 11. When a user's finger is in contact with the fingerprint reader 112, the fingerprint reader 112 is triggered to read a fingerprint information of the user's finger. In case that the fingerprint reader 112 is in a sleep mode, the fingerprint reader 112 is switched to a working mode after the fingerprint reader 112 is triggered.

When the fingerprint reader 112 is in the working mode, the fingerprint reader 112 detects whether the user's finger is in contact with the fingerprint reader 112 at a first frequency. When the fingerprint reader 112 is in the sleep mode, the fingerprint reader 112 detects whether the user's finger is contact with the fingerprint reader 112 at a second frequency. The second frequency is lower than the first frequency. That is, even if the fingerprint reader 112 is in the sleep mode, the user can touch the fingerprint reader 112 to trigger the fingerprint reader 112. After the fingerprint reader 112 is triggered, the fingerprint reader 112 is switched from the sleep mode to the working mode.

The power switch 113 is also disposed on the remote controller 11 and exposed outside the remote controller 11. By triggering the power switch 113, the smart TV 12 is selectively powered on or powered off. The first controlling unit 114 is connected with the input interface 111, the fingerprint reader 112 and the power switch 113. The first controlling unit 114 is used for generating the corresponding operating signal S3 in response to the user's operation on the input interface 111, receiving the fingerprint information from the fingerprint reader 112 or generating an on signal S1 or an off signal S2 in response to the triggering action of the power switch 113. The first wireless transmission module 115 is connected with the first controlling unit 114. Moreover, when the first wireless transmission module 115 is in wireless connection with the smart TV 12, the operating signal S3, the on signal S1, the off signal S2 and the fingerprint information can be transmitted to the smart TV 12 by a wireless transmission technology. Preferably but not exclusively, the input interface 111 includes plural keys. In another embodiment, the input interface is a touch-sensitive interface.

The smart TV 12 comprises a display screen 121, a stereo device 122, a storage element 123, a second wireless transmission module 124, an identification unit 125 and a second controlling unit 126. The display screen 121 is exposed outside the smart TV 12. The display screen 121 is used for displaying a television picture of a TV channel, a TV program schedule or an operating interface. The stereo device 122 is used for outputting the sound effect of TV program of the TV channel. The storage element 123 is disposed within the smart TV 12, and used for storing plural fingerprint templates It1˜Itn. The storage element 123 storing the plural fingerprint templates It1˜Itn is also defined as a fingerprint database. When the second wireless transmission module 124 is in wireless connection with the first wireless transmission module 115, the operating signal S3, the on signal S1, the off signal S2 and the fingerprint information from the remote controller 11 are received by the second wireless transmission module 124. The identification unit 125 is connected with the storage element 123 and the second wireless transmission module 124. After the fingerprint information is received by the smart TV 12, the identification unit 125 will compare the fingerprint information with the plural fingerprint templates It1˜Itn, thereby judging whether the fingerprint information is authenticated. If the identification unit 125 judges that the fingerprint information is authenticated, a successful authentication message M1 is transmitted from the identification unit 125 to the second controlling unit 126. The second controlling unit 126 is connected with the second wireless transmission module 124 and the identification unit 125. The second controlling unit 126 is used for controlling the smart TV 12 to perform a corresponding operation. In addition, if the successful authentication message from the identification unit 125 is received, the second controlling unit 126 controls the smart TV 12 to enters a user mode corresponding to the authenticated fingerprint information.

In an embodiment, the wireless connection between the first wireless transmission module 115 and the second wireless transmission module 124 is established by an infrared transmission technology, a Bluetooth transmission technology or a Wi-Fi transmission technology, the identification unit 125 is a software component or a firmware component in the smart TV 12, and the first controlling unit 114 and the second controlling unit 126 are microprocessors or control chips.

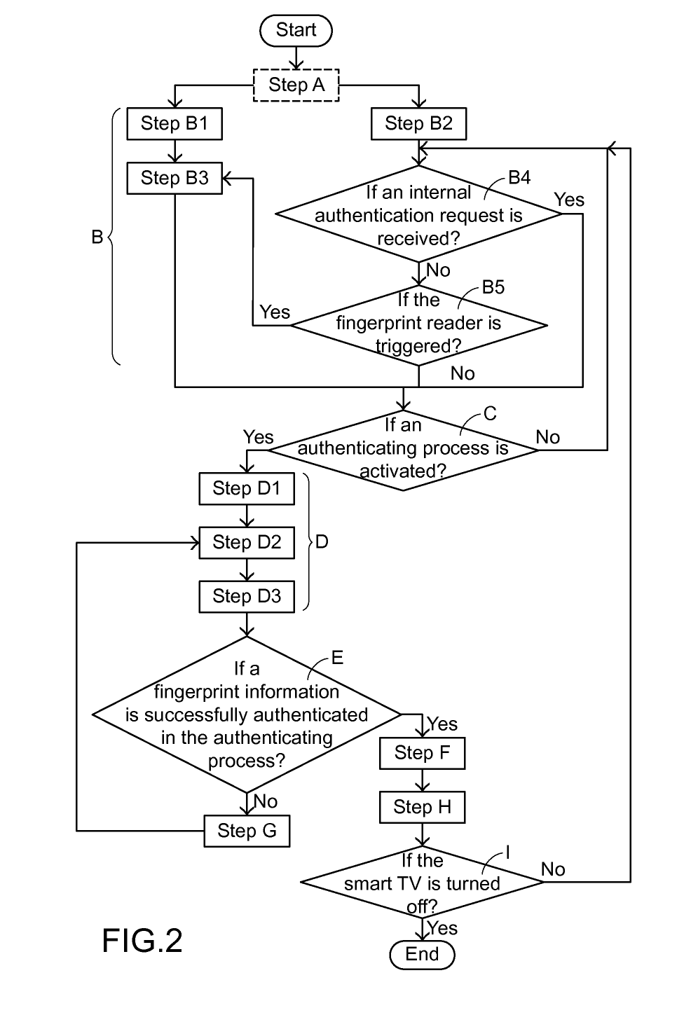

The steps of the smart TV control method will be illustrated in more details as follows. FIG. 2 is a flowchart illustrating a smart TV control method according to a first embodiment of the present invention. The smart TV control method comprises the following steps.

In a step A, a fingerprint database is created in the smart TV. In a step B, the smart TV is turned on through the remote controller. In a step C, the smart TV judges whether an authenticating process is activated. In a step D, the smart TV performs the authenticating process. In a step E, the smart TV judges whether a fingerprint information is successfully authenticated in the authenticating process. In a step F, the smart TV enters a user mode and controls the fingerprint reader to enter a sleep mode. In a step G the smart TV provides a failed authentication message. In a step H, the smart TV performs a task in response to an operation on the remote controller. The step I is performed to judge whether the smart TV is turned off.

In the step C, if the smart TV judges that the authenticating process is activated, the step D is performed. Whereas, if the smart TV judges that the authenticating process is not activated, the step C is performed again. In the step E, if the smart TV judges that the fingerprint information is successfully authenticated in the authenticating process, the step F is performed. Whereas, if the smart TV judges that the fingerprint information is not successfully authenticated in the authenticating process, the step G is performed. After the step G is completed, the step D is performed again. If the result of the step I indicates that the smart TV is turned off, this smart TV control method is completed. Whereas, if the result of the step I indicates that the smart TV is not turned off, the step B is repeatedly done.

The step B comprises sub-steps B1, B2, B3, B4 and B5. In the sub-step B1, the fingerprint reader of the remote controller is triggered to establish the wireless connection between the remote controller and the smart TV. In the sub-step B2, the power switch of the remote controller is triggered to establish the wireless connection between the remote controller and the smart TV. In the sub-step B3, an external authentication request is transmitted from the remote controller to the smart TV by a wireless transmission technology after the fingerprint reader is triggered. In the sub-step B4, the identification unit judges whether an internal authentication request is received. In the sub-step B5, the first controlling unit judges whether the fingerprint reader is triggered.

In the sub-step B4, if the identification unit 125 receives the internal authentication request after the power switch is triggered, the step C is performed. Whereas, if the identification unit 125 does not receive the internal authentication request after the power switch is triggered, the sub-step B5 is repeatedly done. In the sub-step B5, if the first controlling unit 114 judges that the fingerprint reader is triggered after the power switch is triggered, the sub-step B3 is performed. Whereas, if the first controlling unit 114 judges that the fingerprint reader is not triggered after the power switch is triggered, the sub-step C is performed.

The step D comprises sub-steps D1, D2 and D3. In the sub-step D1, the smart TV generates a fingerprint provision prompt in response to the external authentication request or the internal authentication request. In the sub-step D2, the remote controller receives the fingerprint information that is obtained by the fingerprint reader, and transmits the fingerprint information to the smart TV. In the sub-step D3, the smart TV compares the fingerprint information with the plural fingerprint templates in the fingerprint database.

Hereinafter, the operations of the smart TV control method will be illustrated with reference to FIGS. 1 and 2. Firstly, in the step A, a fingerprint database is created in the smart TV. The detailed procedures of the step A will be illustrated as follows. After a first user touches the fingerprint reader 112 of the remote controller 11, the first controlling unit 114 acquires a fingerprint information If1 of the first user. Through the first wireless transmission module 115, the fingerprint information If1 is transmitted from the first controlling unit 114 to the second wireless transmission module 124 of the smart TV 12. Then, the fingerprint information If1 is stored into the storage element 123 by the second controlling unit 126. In addition, the fingerprint information If1 is saved as a fingerprint template It1. The above step A is repeatedly done by plural users. Consequently, plural fingerprint templates It1˜Itn are stored in the storage element 123. That is, different fingerprint templates correspond to different users.

In an embodiment, the plural users sequentially touch the fingerprint reader 112 to transmit the fingerprint informations If1˜Ifn to the smart TV 12, and the fingerprint informations If1˜Ifn are saved as the corresponding fingerprint templates It1˜Itn by the second controlling unit 126. The above example is presented herein for purpose of illustration and description only. In another embodiment of the step A, the fingerprint templates It1˜Itn are stored into a third-party device (e.g., a computer) through the third-party device, and the fingerprint templates It1˜Itn are transmitted from the third-party device to the smart TV so as to create the fingerprint database.

Regardless of whether the smart TV 12 is turned on, the first user can touch the fingerprint reader 112 of the remote controller 11 after the fingerprint database is created. Consequently, the fingerprint reader 112 is switched from the sleep mode to the working mode, and the fingerprint reader 112 notifies the first controlling unit 114 to establish the wireless connection between the first controlling unit 114 and the smart TV 12. That is, the first controlling unit 114 is in wireless connection with the second wireless transmission module 124 through the first wireless transmission module 115. Meanwhile, the sub-step B1 is performed. Since the user continuously touches the fingerprint reader 112 to trigger the fingerprint reader 112, an external authentication request R1 corresponding to the fingerprint reader 112 is transmitted from the first controlling unit 114 to the smart TV 12 by a wireless transmission technology after the fingerprint reader 112 is triggered. That is, the sub-step B3 is performed. Meanwhile, the step B is completed, and the subsequent step C is ready.

After the external authentication request R1 corresponding to the fingerprint reader 112 is received by the identification unit 125 of the smart TV 12, the identification unit 125 judges that the authenticating process is activated (i.e., in the step C). Then, the second controlling unit 126 performs the sub-step D1. In the sub-step D1, the second controlling unit 126 controls the smart TV 12 to generate a fingerprint provision prompt in response to the external authentication request R1. For example, the fingerprint provision prompt is a message “please provide a fingerprint” that is shown on the display screen 121, or the fingerprint provision prompt is a sound effect “please provide a fingerprint” that is outputted from the stereo device 122. The fingerprint provision prompt can warn the user to touch the fingerprint reader 112 with a finger so as to provide the fingerprint information. After the first user provides the fingerprint information If1 through the fingerprint reader 112, the first controlling unit 114 receives the fingerprint information If1 and transmits the fingerprint information If1 to the identification unit 125. Meanwhile, the sub-step D2 is performed. After the fingerprint information If1 is received by the identification unit 125, the sub-step D3 is performed. In the sub-step D3, the fingerprint information If1 is compared with the plural fingerprint templates It1˜Itn in the fingerprint database successively.

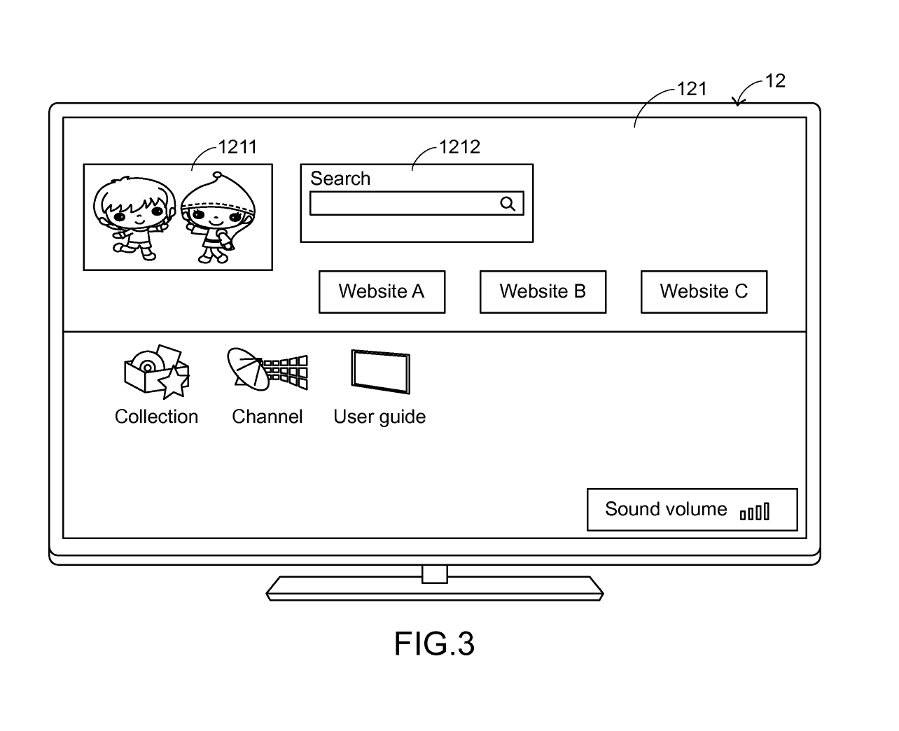

If the identification unit 125 judges that the fingerprint information If1 complies with the fingerprint template It1 according to the comparing result, the identification unit 125 judges that the fingerprint information is successfully authenticated in the authenticating process (i.e., in the step E,). Consequently, a successful authentication message M1 is transmitted from the identification unit 125 to the second controlling unit 126. Then, the second controlling unit 126 performs the step F. In the step F, the second controlling unit 126 controls the smart TV 12 to enter a user mode corresponding to the fingerprint information If1 (i.e., the user mode corresponding to the first user). In particular, a window-based user interface corresponding to the fingerprint information If1 is shown on the display screen 121 under control of the second controlling unit 126. The window-based user interface contains plural TV channels that are preset by the first user. In addition, the stereo device 122 is switched to a broadcast setting mode corresponding to the fingerprint information If1 under control of the second controlling unit 126. The contents of the display screen 121 in the first user mode are shown in FIG. 3.

For example, as shown in FIG. 3, the user mode corresponding to the first user is created according to the preference and use practice of the first user. A TV program preview window 1211 at an upper left corner of FIG. 3 indicates the TV program of a specified TV channel. In addition, a search box 1212 is located at the right side of the TV program preview window 1211. Through the search box 1212, the first user can search the desired TV channels, TV programs, websites or other information.

Through a collection shortcut under the TV program preview window 1211, the TV channels, the TV programs or the websites that are collected according to the settings of the first user can be accessed. Through a channel shortcut, all TV channels can be accessed. Through a user guide item, the instructions about the smart TV 12 can be displayed. A sound volume indicator at a lower right corner of FIG. 3 indicates that the sound level of the stereo device 122 set by the first user is 3. That is, under control of the second controlling unit 126, the smart TV 12 is switched to the user mode that is preset by the first user. Consequently, the first user can operate the smart TV 12 more conveniently. On the other hand, the second controlling unit 126 also issues a notification signal to the remote controller 11. In response to the notification signal, the remote controller 11 controls the fingerprint reader 112 to enter the sleep mode. Consequently, the power-saving efficacy of the remote controller 11 is enhanced.

Then, the smart TV 12 performs the step H. In the step H, the smart TV 12 performs a task in response to an operation on the remote controller 11. Moreover, after the TV program watched by the first user is ended, the first user may trigger the power switch 112 to issue the off signal S2 to the smart TV 12. In response to the off signal S2, the smart TV 12 is turned off. That is, in the step I, the second controlling unit 126 judges that the smart TV 12 is turned off when the off signal S2 is received. Then, the smart TV control method is ended. Whereas, in the step I, if the second controlling unit 126 judges that the smart TV 12 is not turned off, the step B4 is performs to judge whether an internal authentication request R2 is received. The above implementation example of the smart TV control method describes the subsequent steps after the user touches the fingerprint reader 112 to turn on the smart TV 12.

The above implementation example is one of various implementation examples of the smart TV control method according to the present invention. Hereinafter, another implementation example of the smart TV control method by triggering the power switch 113 to turn on the smart TV 12 will be illustrated in more details. Please refer to FIGS. 1 and 2. When a second user wants to watch the smart TV 12, the second user may operate the smart TV control method of the present invention to control the smart TV 12. After the fingerprint database is created, it is not necessary to perform the step A again unless a new fingerprint template is added to the storage element 123. Since the second user does not intend to add the new fingerprint template, the step A is skipped and the sub-step B2 is performed. In the sub-step B2, the second user touches the power switch 113 of the remote controller 11. The on signal S1 corresponding to the power switch 113 is transmitted from the first controlling unit 114 to the second wireless transmission module 124 of the smart TV 12 through the first wireless transmission module 115. Consequently, the smart TV 12 is turned on. Then, even if the second user is not authenticated, the second user can use the remote controller 11 to control the smart TV 12 in order to perform the corresponding task. On the other hand, if the second user selects an account of the second user through the input interface 111 to purchase pay channels, the second controlling unit 126 issues an internal authentication request R2 to the identification unit 125 because the second user is not authenticated at this moment. At the same time, the second controlling unit 126 notifies the remote controller 11 to wake up the fingerprint reader 112. Consequently, the fingerprint reader 112 is switched from the sleep mode to the working mode under control of the first controlling unit 114. Moreover, since the identification unit 125 judges that the internal authentication request R2 is received in the sub-step B4, the subsequent step C will be performed.

After the internal authentication request R2 is received by the identification unit 125, the identification unit 125 judges that the authenticating process is activated (i.e., in the step C). Then, the second controlling unit 126 performs the sub-step D1. In the sub-step D1, the second controlling unit 126 controls the smart TV 12 to generate a fingerprint provision prompt in response to the internal authentication request R2. After the second user touches the fingerprint reader 112 to provide the fingerprint information If2 corresponding to the second user, the first controlling unit 114 performs the sub-step D2. In the sub-step D2, the first controlling unit 114 receives the fingerprint information If2 and transmits the fingerprint information If2 to the identification unit 125. Then, the identification unit 125 performs the sub-step D3. In the sub-step D3, the fingerprint information If2 is compared with the plural fingerprint templates It1˜Itn in the fingerprint database successively.

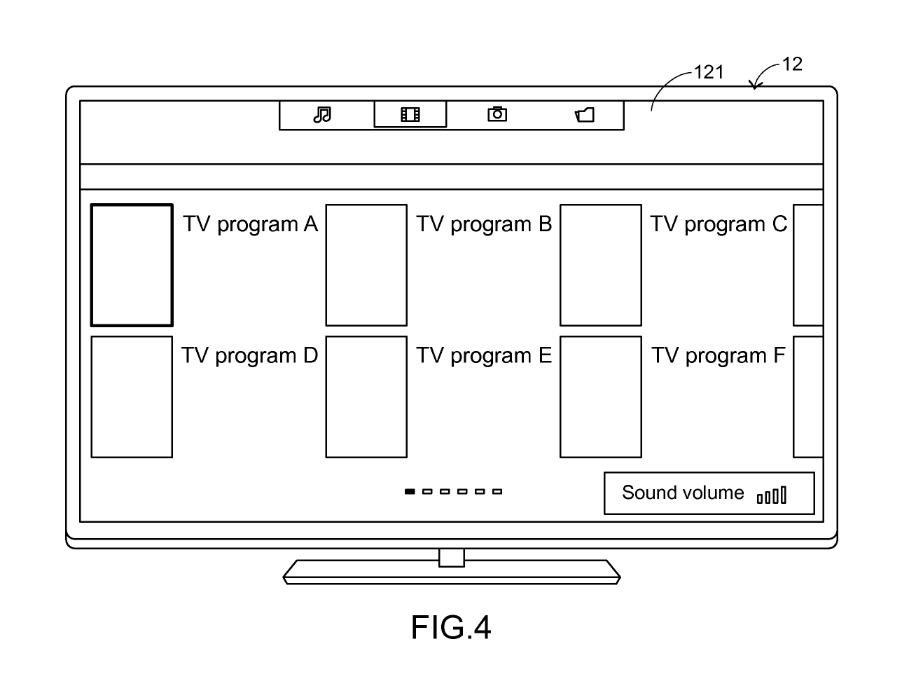

If the identification unit 125 judges that the fingerprint information If2 does not comply with all fingerprint templates It1˜Itn according to the comparing result, it means that the fingerprint reader 112 is inaccurately touched by the second user and thus the fingerprint reader 112 is unable to read the complete fingerprint. Consequently, in the step E, the identification unit 125 judges that the fingerprint information If2 is not successfully authenticated in the authenticating process. Meanwhile, the identification unit 125 issues a failed authentication message M2 to the second controlling unit 126. In particular, the second controlling unit 126 controls the display screen 121 or the stereo device 122 to output the failed authentication message M2 to warn the second user. In response to the failed authentication message M2, the second user can touch the fingerprint reader 112 again to provide the accurate fingerprint information If2. Meanwhile, the sub-step D2 is performed. Then, the sub-step D3 and the step E are sequentially performed. In the step E, the identification unit 125 judges that the fingerprint information is successfully authenticated in the authenticating process. Consequently, the successful authentication message M1 is transmitted from the identification unit 125 to the second controlling unit 126. Then, the second controlling unit 126 performs the step F. In the step F, the second controlling unit 126 controls the smart TV 12 to enter a user mode corresponding to the fingerprint information If2 (i.e., the user mode corresponding to the second user). The contents of the display screen 121 in the second user mode are shown in FIG. 4.

As shown in FIG. 4, the user mode corresponding to the second user is created according to the preference and use practice of the second user. Moreover, plural TV channels that are frequently used by the second user are shown on the display screen 121. A sound volume indicator at a lower right corner of FIG. 4 indicates that the set sound level of the stereo device 122 is 4. From FIGS. 3 and 4, it is found that the user modes set by different users are different. The subsequent steps H and I are similar to those mentioned above, and are not redundantly described herein.

Another implementation example of the smart TV control method will be illustrated as follows. This implementation example is similar to the above implementation example of triggering the power switch 113 to turn on the smart TV 12. The step A is skipped, and the sub-steps B2 and B4 are performed. If the identification unit 125 judges that the internal authentication request R2 is not received in the sub-step B4, the sub-step B5 will be performed. When the second user touches the fingerprint reader 112 with a finger, the fingerprint information If2 of the second user is received by the remote controller 11. Since the first controlling unit 114 judges that the fingerprint reader 112 is triggered in the sub-step B5, the sub-step B3 is performed. In the sub-step B3, an external authentication request R1 corresponding to the fingerprint reader 112 is transmitted from the first controlling unit 114 to the smart TV 12 by a wireless transmission technology. Whereas, if the first controlling unit 114 judges that the fingerprint reader 112 is not triggered in the sub-step B5, the subsequent step C is performed. The subsequent steps C, D, E, F, H, G and I are similar to those mentioned above, and are not redundantly described herein.

Moreover, if the wireless signal from the first controlling unit 114 is received by the smart TV 12 during wireless transmission, the second controlling unit 126 generates a corresponding feedback signal. Similarly, if the wireless signal from the second controlling unit 126 is received by the remote controller 11 during wireless transmission, the first controlling unit 114 also generates a corresponding feedback signal. The way of generating the feedback signal is well known to those skilled in the art and is not the subject matter of the present invention. Consequently, the detailed descriptions thereof are omitted.

From the above descriptions, the present invention provides a smart TV control method. By the smart TV control method, the smart TV is allowed to enter a user mode corresponding to the authenticated fingerprint information. That is, the user neither memorizes the account and the password nor inputs the account and the password into the smart TV. Consequently, the process of allowing the user to login into the smart TV will be simplified. Moreover, after the authenticating process for the smart TV is completed, the remote controller controls the fingerprint reader to enter the sleep mode. Since the power consumption is reduced, the power-saving efficacy of the remote controller is enhanced.

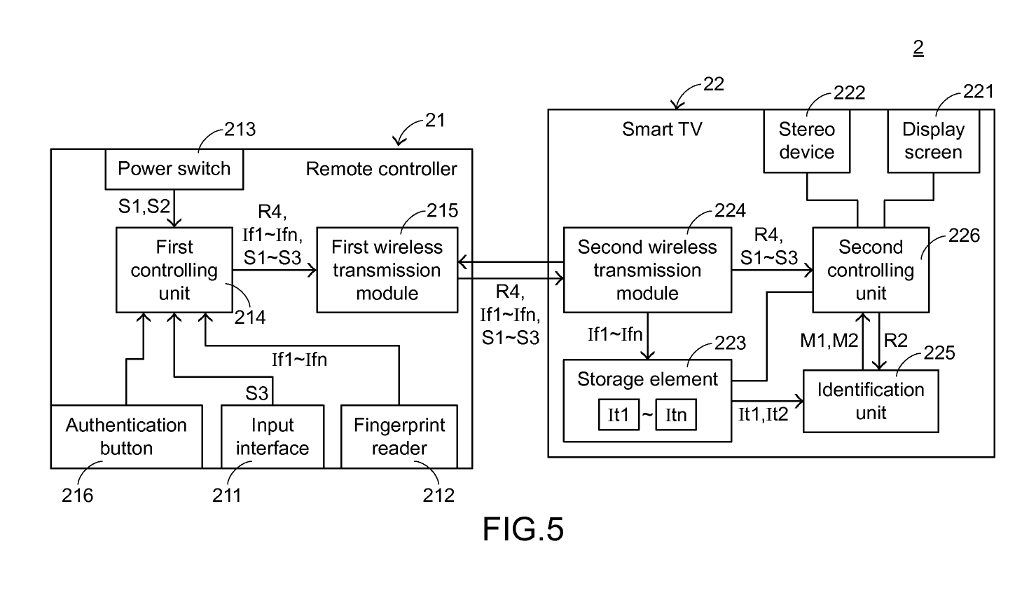

The present invention further comprises a second embodiment. FIG. 5 is a schematic functional block diagram illustrating a control system for implementing a smart TV control method according to a second embodiment of the present invention. As shown in FIG. 5, the control system 2 comprises a remote controller 21 and a smart TV 22. The remote controller 21 comprises an input interface 211, a fingerprint reader 212, a power switch 213, a first controlling unit 214, a first wireless transmission module 215 and an authentication button 216. The smart TV 22 comprises a display screen 221, a stereo device 222, a storage element 223, a second wireless transmission module 224, an identification unit 225 and a second controlling unit 226. Except that the remote controller 21 further comprises the authentication button 216, the other components of the control system 2 are similar to those of the control system 1 of the first embodiment, and are not redundantly described herein. The authentication button 216 is disposed on the remote controller 21 and exposed outside the remote controller 21. After the authentication button 216 is triggered, an external authentication request R3 corresponding to the authentication button 216 is transmitted from the remote controller 21 to the smart TV 22. Due to the arrangement of the authentication button 216, the function of the fingerprint reader 212 of this embodiment is somewhat different from the function of the fingerprint reader 112 of the first embodiment. In contrast, when the fingerprint reader 212 is in the sleep mode, the finger's touch on the fingerprint reader 212 will not wake up the fingerprint reader 212. Consequently, even if the fingerprint reader 212 is carelessly touched, the fingerprint reader 212 will not be triggered.

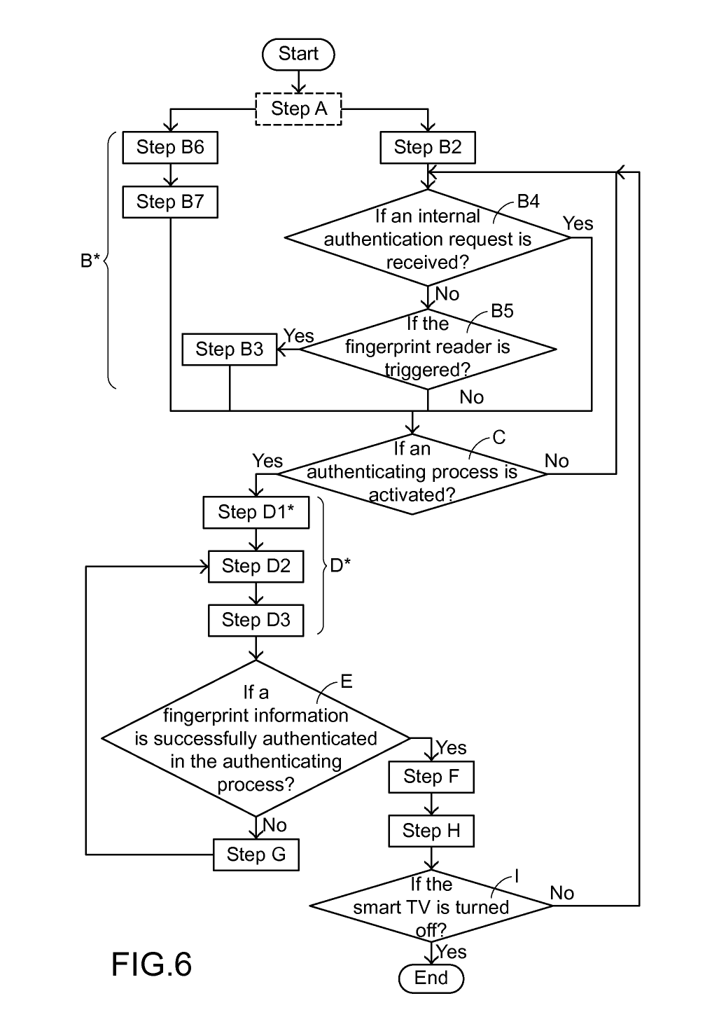

The steps of the smart TV control method will be illustrated in more details as follows. FIG. 6 is a flowchart illustrating a smart TV control method according to a second embodiment of the present invention. The smart TV control method comprises the following steps.

In a step A, a fingerprint database is created in the smart TV. In a step B*, the smart TV is turned on through the remote controller. In a step C, the smart TV judges whether an authenticating process is activated. In a step D*, the smart TV performs the authenticating process. In a step E, the smart TV judges whether a fingerprint information is successfully authenticated in the authenticating process. In a step F, the smart TV enters a user mode and controls the fingerprint reader to enter a sleep mode. In a step G the smart TV provides a failed authentication message. In a step H, the smart TV performs a task in response to an operation on the remote controller. The step I is performed to judge whether the smart TV is turned off.

In the step C, if the smart TV judges that the authenticating process is activated, the step D* is performed. Whereas, if the smart TV judges that the authenticating process is not activated, the step C is performed again. In the step E, if the smart TV judges that the fingerprint information is successfully authenticated in the authenticating process, the step F is performed. Whereas, if the smart TV judges that the fingerprint information is not successfully authenticated in the authenticating process, the step G is performed. After the step G is completed, the step D* is performed again. If the result of the step I indicates that the smart TV is turned off, this smart TV control method is completed. Whereas, if the result of the step I indicates that the smart TV is not turned off, the step B is repeatedly done. The steps A, C and E˜I are similar to those mentioned above, and are not redundantly described herein. In comparison, the step B of the first embodiment is replaced by the step B* of this embodiment, and the step D of the first embodiment is replaced by the step D* of this embodiment.

The step B* comprises sub-steps B2, B3, B4, B5, B6 and B7. In the sub-step B2, the power switch of the remote controller is triggered to establish the wireless connection between the remote controller and the smart TV. In the sub-step B3, an external authentication request is transmitted from the remote controller to the smart TV by a wireless transmission technology after the fingerprint reader is triggered. In the sub-step B4, the identification unit judges whether an internal authentication request is received. In the sub-step B5, the first controlling unit judges whether the fingerprint reader is triggered. In the sub-step B6, the authentication button of the remote controller is triggered to establish the wireless connection between the remote controller and the smart TV. In the sub-step B7, an external authentication request is transmitted from the remote controller to the smart TV by a wireless transmission technology after the authentication button is triggered.

The step D* comprises sub-steps D1*, D2 and D3. In the sub-step D1*, the smart TV wakes up the fingerprint reader and generates a fingerprint provision prompt in response to the external authentication request or the internal authentication request. In the sub-step D2, the remote controller receives the fingerprint information that is obtained by the fingerprint reader, and transmits the fingerprint information to the smart TV. In the sub-step D3, the smart TV compares the fingerprint information with the plural fingerprint templates in the fingerprint database.

Hereinafter, the operations of the smart TV control method will be illustrated with reference to FIGS. 5 and 6. Firstly, the step A as described in the first embodiment is performed, so that a fingerprint database is created in the smart TV. After the fingerprint database is created and the first user touches the authentication button 216 of the remote controller 21, the first controlling unit 214 is in wireless connection with the second wireless transmission module 224 through the first wireless transmission module 215. Meanwhile, the sub-step B6 is performed. After the authentication button 216 is triggered, an external authentication request R4 corresponding to the authentication button 216 is transmitted from the first controlling unit 214 to the smart TV 22 by a wireless transmission technology. That is, the sub-step B7 is performed. Meanwhile, the step B is completed, and the subsequent step C is ready.

After the external authentication request R4 is received by the identification unit 225 of the smart TV 22, the identification unit 225 judges that the authenticating process is activated (i.e., in the step C). Then, the second controlling unit 226 performs the sub-step D1*. In the sub-step D1*, the second controlling unit 226 notifies the first controlling unit 214 to wake up the fingerprint reader 212 and generates a fingerprint provision prompt in response to the external authentication request R4. The fingerprint provision prompt can warn the user to touch the fingerprint reader 212 with a finger so as to provide the fingerprint information. After the fingerprint reader 212 is switched from the sleep mode to a working mode, the first user provides the fingerprint information If1 through the fingerprint reader 212. Consequently, the first controlling unit 214 receives the fingerprint information If1 and transmits the fingerprint information If1 to the identification unit 225. Meanwhile, the sub-step D2 is performed. After the fingerprint information If1 is received by the identification unit 225, the sub-step D3 is performed. In the sub-step D3, the fingerprint information If1 is compared with the plural fingerprint templates It1˜Itn in the fingerprint database successively. The subsequent steps E, F, H, G and I are similar to those mentioned above, and are not redundantly described herein.

The above implementation example of the smart TV control method describes the subsequent steps after the user touches the second controlling unit 226 to turn on the smart TV 22. Another implementation example of triggering the power switch 213 to turn on the smart TV 22 is similar to that of the first embodiment except that the step D1* is distinguished.

In this embodiment of the smart TV control method, the fingerprint reader 212 is designed to have the function of avoiding careless touch. Consequently, if the fingerprint reader 212 is carelessly touched, the authenticating process is not activated. That is, when the fingerprint reader 212 is in the sleep mode, the finger's touch on the fingerprint reader 212 will not switch the sleep mode of the fingerprint reader 212 to the working mode. In particular, the fingerprint reader 212 in the sleep mode will not detect whether the user′ finger is in contact with the fingerprint reader 212, so that the power-saving efficacy of the remote controller is enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A smart TV control method, comprising steps of:
turning on a smart TV through a remote controller;
the smart TV judging whether an authenticating process is activated;
if the smart TV judges that the authenticating process is activated, receiving a fingerprint information from a fingerprint reader of the remote controller and starting to perform the authenticating process;
the smart TV judging whether the fingerprint information is successfully authenticated in the authenticating process; and
if the smart TV judges that the fingerprint information is successfully authenticated in the authenticating process, the smart TV entering a user mode corresponding to the authenticated fingerprint information, and the smart TV controlling the fingerprint reader to enter a sleep mode.

2. The smart TV control method according to claim 1, wherein before the smart TV is turned on through the remote controller, the smart TV control method further comprises a step of creating a fingerprint database in the smart TV, wherein the fingerprint database stores plural fingerprint templates corresponding to plural users.

3. The smart TV control method according to claim 2, wherein the step of turning on the smart TV through the remote controller comprises sub-steps of:
triggering the fingerprint reader of the remote controller to establish a wireless connection between the remote controller and the smart TV; and
transmitting an external authentication request from the remote controller to the smart TV by a wireless transmission technology after the fingerprint reader is triggered.

4. The smart TV control method according to claim 3, wherein the step of receiving the fingerprint information from the fingerprint reader of the remote controller and starting to perform the authenticating process comprises sub-steps of:
the smart TV generating a fingerprint provision prompt in response to the external authentication request corresponding to the fingerprint reader;
the remote controller receiving the fingerprint information that is obtained by the fingerprint reader, and transmitting the fingerprint information to the smart TV; and
the smart TV comparing the fingerprint information with the plural fingerprint templates in the fingerprint database.

5. The smart TV control method according to claim 2, wherein the step of turning on the smart TV through the remote controller comprises sub-steps of:
triggering an authentication button of the remote controller to establish a wireless connection between the remote controller and the smart TV; and
transmitting an external authentication request from the remote controller to the smart TV by a wireless transmission technology after the authentication button is triggered.

6. The smart TV control method according to claim 5, wherein the step of receiving the fingerprint information from the fingerprint reader of the remote controller and starting to perform the authenticating process comprises sub-steps of:
the smart TV generating a fingerprint provision prompt in response to the external authentication request corresponding to the authentication button;
the remote controller receiving the fingerprint information that is obtained by the fingerprint reader, and transmitting the fingerprint information to the smart TV; and
the smart TV comparing the fingerprint information with the plural fingerprint templates in the fingerprint database.

7. The smart TV control method according to claim 2, wherein the step of turning on the smart TV through the remote controller comprises sub-steps of:
triggering a power switch of the remote controller to establish a wireless connection between the remote controller and the smart TV; and
transmitting an external authentication request from the remote controller to the smart TV by a wireless transmission technology after an authentication button of the remote controller or the fingerprint reader is triggered.

8. The smart TV control method according to claim 7, wherein the step of receiving the fingerprint information from the fingerprint reader of the remote controller and starting to perform the authenticating process comprises sub-steps of:
the smart TV generating a fingerprint provision prompt in response to the external authentication request corresponding to the authentication button or the external authentication request corresponding to the fingerprint reader;
the remote controller receiving the fingerprint information that is obtained by the fingerprint reader, and transmitting the fingerprint information to the smart TV; and
the smart TV comparing the fingerprint information with the plural fingerprint templates in the fingerprint database.

9. The smart TV control method according to claim 1, wherein in the step of judging whether the authenticating process is activated, if the smart TV receives an external authentication request from the remote controller or if the smart TV is operated and an internal authentication request is generated by the smart TV, the smart TV judges that the authenticating process is activated.

10. The smart TV control method according to claim 9, wherein if the smart TV receives the external authentication request corresponding to an authentication button of the remote controller or receives the internal authentication request, the fingerprint reader is switched from the sleep mode to a working mode under control of the smart TV.

11. The smart TV control method according to claim 2, wherein in the step of judging whether the fingerprint information is successfully authenticated in the authenticating process, the smart TV judges that the fingerprint information is successfully authenticated if the fingerprint information complies with one of the plural fingerprint templates of the fingerprint database, or the smart TV judges that the fingerprint information is not authenticated and provides a failed authentication message if the fingerprint information does not comply with all of the plural fingerprint templates of the fingerprint database.

12. The smart TV control method according to claim 1, wherein after the smart TV enters the user mode corresponding to the authenticated fingerprint information and the smart TV controls the fingerprint reader to enter the sleep mode, the smart TV control method further comprises steps of:
the smart TV performing a task in response to an operation on the remote controller;
judging whether the smart TV is turned off; and
if the smart TV is not turned off, the smart TV judging again whether the authenticating process is activated.
